(19) United States
(12) Patent Application Publication
(10) Pub. No.: US 2017/0026967 A1
(43) Pub. Date: Jan. 26, 2017

(54) Radio Signal Sequence, Transmitter, Receiver, Device, and Data Link System

(71) Applicant: ATLAS ELEKTRONIK GMBH, Bremen (DE)

(72) Inventor: Hans-Günter MIESNER, Rotenburg (DE)

(21) Appl. No.: 15/301,303

(22) PCT Filed: Feb. 10, 2015
(86) PCT No.: PCT/DE2015/100053

§ 371 Date: Sep. 30, 2016

(30) Foreign Application Priority Data
Apr. 2, 2014 (DE) 10 2014 104 691.9

(51) Int. Cl. H04W 72/04; H04L 29/08; H04B 1/3822

(52) U.S. Cl. CPC H04W 72/0446; H04B 1/3822; H04L 67/12

(57) ABSTRACT

The invention relates to a radio signal sequence—in particular, having an HF or UHF carrier frequency—for distributing information in a data link system by using a first frame and a second frame, wherein the first frame having a first bit sequence is assigned to a first time slot, and the second frame having a second bit sequence is assigned to a second time slot, wherein a chronological sequence of the first frame and of the second frame or of the first bit sequence or of the second bit sequence is defined on the basis of a sensor result.

The invention relates to a radio signal sequence—in particular, having an HF or UHF carrier frequency—for distributing information in a data link system by using a first frame and a second frame, wherein the first frame having a first bit sequence is assigned to a first time slot, and the second frame having a second bit sequence is assigned to a second time slot. The invention furthermore relates to a transmitter, a receiver, an apparatus, and a data link system.

Data link systems are, in particular, used in the military sector. A data link system uses a connection between one or several terminals for data transmission. The actual transmission may generally be accomplished via data cables, wirelessly by a radio connection, or optically. Various protocols have been established for such data links. Examples to be named here are ACARS, JTIDS, and MIDS.

The data capacity is very low, especially in case of radio transmissions. This means that tactical data such as, for example, the position, the velocity, and the direction of a missile or a vessel are renewed regularly to ensure that an all-around “map” with all tactical data is available. Any emitted radio signals and, therefore, the underlying protocols as well are barely able to react to rapid changes in the situation. Instead, each time, all the information is determined and communicated to all participants connected to the data link system.

The purpose of the invention is to improve the state of the art.

This task is solved by a radio signal sequence—in particular, with an HF or UHF carrier frequency—for distributing information in a data link system with a first frame and a second frame, wherein the first frame having a first bit sequence is assigned to a first time slot, and the second frame having a second bit sequence is assigned to a second time slot, wherein a chronological sequence of the first frame and of the second frame or of the first bit sequence or of the second bit sequence is defined on the basis of a sensor result.

This allows the provision of a data link system that can determine a radio signal sequence based upon sensor signals and the parameters derived from the sensors.

This makes it possible for a radar, for example, to determine the position and the velocity of an approaching aircraft or ship. As soon as the direction and the speed show critical values from which it can be deduced that the approaching vessel may possibly be approaching with hostile intent, the data regarding this hostile vehicle can be transmitted with priority to all participants in the data link system via the radio signal sequence.

Conversely, information regarding a vehicle that is distancing itself from one's own position or the position of other vehicles in the unit may, for example, be treated with low priority, so that information regarding the vehicle moving away is only transmitted to the participants of the data link system every few minutes.

The following terms need explanation:

“Radio” especially comprises the radio technology that provides a method of wirelessly transferring signals of all kinds by using modulated electromagnetic waves in the radio frequency range (radio waves). HF is the abbreviation for high frequency, which especially comprises the frequency range from 3 MHz to 30 MHz. Alternative terms used for such radio waves are short waves or decameter waves. The abbreviation UHF represents the term ultra-high frequency and, in particular, includes microwaves whose wave lengths are in the decimeter range, i.e., between 10 dm and 1 dm. This corresponds especially to a frequency range of 0.3 GHz to 3 GHz. Presently, however, the ranges between 30 MHz and 300 Mhz are also included for use as radio.

The “carrier frequency” is also referred to as carrier and is a periodically changing variable of a radio wave with constant characteristic parameters such as, for example, frequency, amplitude, or duty cycle. The carrier signal is, in particular, the reference signal for demodulating a carrier previously subjected to information signal modulation for transmission purposes. Here, the reverse path is also included. The carrier signal and/or the carrier frequency itself can be the information carrier from which the carrier for demodulation is reconstructed, when, for example, the carrier is not transferred as well for certain modulation types. At present, the carrier frequency may also correspond to the nominal frequency of the emitted radio wave.

The “information” includes, in particular, tactical data in a military data link system. Such tactical data may comprise the position, velocity, or the direction of a vehicle or maps and other position information, as well as language or other texts.

In a “data link system,” one refers in particular to connections between two or more terminals between which data transmission occurs. The transmission of data may take place as duplex (data transmission in both directions at the same time is possible), semi-duplex (data transmission in both directions is possible, although not at the same time), and simplex (data is transmitted only in one and the same direction). At present, tactical data links, in particular, such as ACARS, JTIDS and MIDS are examples for data links.

Since, at present, radio signal sequence data is transferred mainly digitally, individual data packs are presently subsumed in a frame. This frame may have both a header and a trailer, as well as the information to be transmitted in coded form. The header may, especially, comprise data for decoding, as well as data length and packet length, while the trailer contains, for example, check digits, e.g., for a CRC test procedure. The frames each have their “bit sequence,” which comprise, for example, information, initially, about position and, finally, language information.

A “bit sequence” comprises, in particular, an item of digital information in the frame. The frame may thus consist of “1's” and “0's”. The entire sequence of the digital signals is referred to as the bit sequence. In addition, the bit sequence may also influence the length of the headers and trailers. The bit sequence, in particular, comprises the information to be transmitted.

In order to ensure effective communication, the frames are assigned to individual “time slots” in which the data packet transmission is to take place. In particular, the data link system allows several participants to send data and/or frames. Each participant may be assigned a fixed time slot for its frame. The time slot assignment may, however, at present also occur dynamically. The dynamics may, especially, be determined by the sensor findings.

In another embodiment, the radio signal sequence has further frames that are each assigned to their own time slots, wherein, especially, the chronological sequence of the frames or the individual bit sequences of the frames are determined by the sensor findings, and the frames form a first transmission cycle.

In this way, for example, a wide, defined transmission cycle may be sent from a main vessel, such as, for example, an aircraft carrier, to the escort vessels in a fleet, and any submarines that are part of the fleet may be assigned a very wide transmission cycle with few frames. This guarantees that optimum distribution of information is ensured.

In order to be able to react even more quickly to changes in a given situation, the radio signal sequence may include other transmission cycles, which in turn have frames with allotted time slots, while their chronological sequence within a transmission cycle is determined on the basis of the sensor findings.

In another embodiment, a scoring algorithm determines the sensor findings. “Sensor findings” in this context may especially refer to the results or the data procured from radar stations, sonar stations, cameras, and optical sensors. Camera, radar, and passive or active sonar data are evaluated in particular. For example, in terms of optical data, the images of an aircraft which have been optically registered by the vessels may be evaluated. In particular, mapping procedures may be used to detect potential enemy aircraft, and this information transmitted to all participants in the data link.

For radar or sonar data, the direction, in particular, and the velocity of vehicles can be determined and potential actions derived from this.

For these scoring algorithms, the sensor results may be evaluated, depending upon the specifications, and, thus, the chronological sequence of the bit sequences or the frames or the transmission cycles influenced.

For example, on the open sea, a fast moving vessel may be identified as dangerous, while, for example, the same near a coast may indicate the usual type of speed boat typically used for leisure purposes. Naturally, these scoring algorithms may be modified by the operating personnel, if required.

In order to determine which information has been transmitted by which participant in the data link system, each frame may be assigned a transmitter which emits the frame.

In a special embodiment, at least two frames originate from at least two independent transmitters. In this way, a data link system with two active participants may be provided. In order to distribute the sensor data themselves or derived parameters of the sensor data in the data link system effectively, the frames may comprise the sensor data or processed sensor data.

Processed sensor data are to be understood as especially derivable variables which are determined by means of mathematical procedures or electronic processing. While, for example, the image itself from a camera is transferable as sensor data, information—in the case of radar data, for instance—such as the size of a vessel, the speed of a ship, and the course of the vessel may be transmitted as processed sensor data.

In order to obtain improved data, e.g., regarding a potential threat, the radio signal sequence may have a control signal which serves to control a second sensor, e.g., at the receiving end of the radio signal sequence. This allows, for example, the main vessel in a naval unit to address the radar system of another ship in the naval unit, in order to improve reconnaissance in certain situations.

In another embodiment of the invention, the aim is achieved by a transmitter with an allocated sensor, with the transmitter being arranged in such a way that a signal sequence described previously may be emitted. This transmitter may especially have a radio antenna that is controlled electronically in such a way as to emit a radio signal sequence.

In order to receive the signal emitted by the transmitter, the aim is also achieved by a receiver that is arranged in such a way that a radio signal sequence described previously or the radio signal sequence emitted by the transmitter can be evaluated.

This allows provision of a transmitter-receiver-pair that provides a data link system.

In one embodiment, the receiver has a sensor that is controllable by means of the radio signal sequence. The receiver in this way may, in particular, receive the radio signal sequence and guide the radar of a ship to a certain point on the basis of the data determined there.

In another embodiment of the invention, the aim is achieved by an apparatus or a vehicle, especially a watercraft, submarine, land vehicle, and/or aircraft which has a transmitter as described above and/or a receiver as described above.

In addition, the aim may be achieved by a data link system that has an apparatus as described above or a vehicle as described above.

The invention is in the following described on the basis of embodiments. Illustrated are:

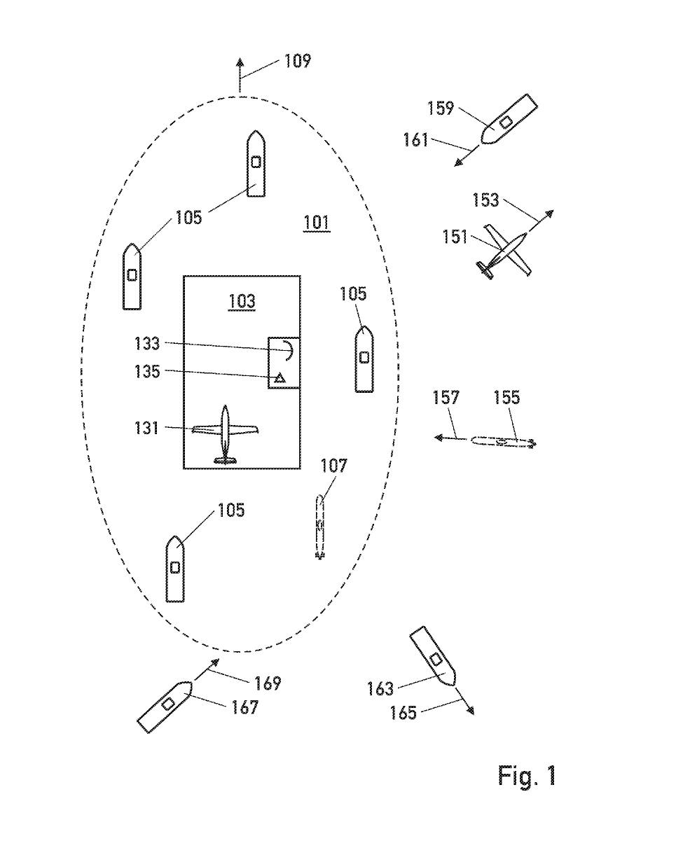

FIG. 1 a schematic representation of a plan view from above of a situation with a naval unit and additional vehicles and

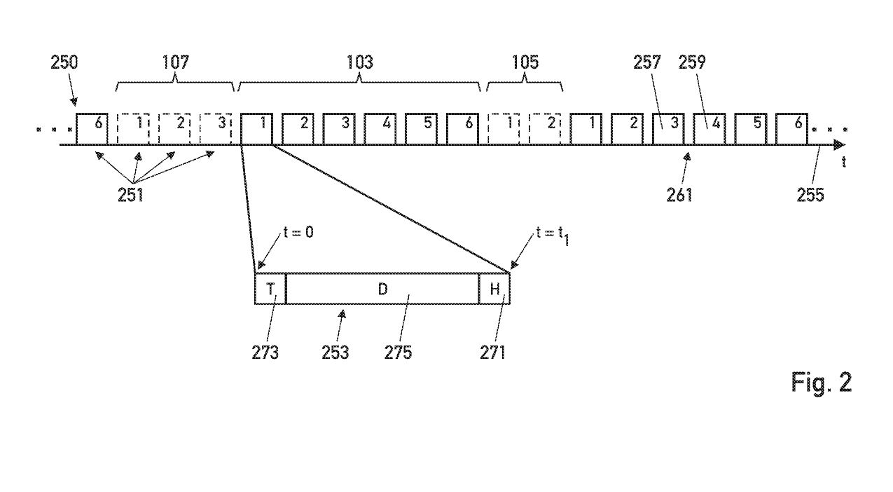

FIG. 2 a radio signal sequence with several frames and transmission cycles, as well as an enlarged representation of a frame

A naval unit 101 includes an aircraft carrier 103 with an aircraft 131, a radar 133, and an HF transmitter/receiver 135. The naval unit 101 also includes escort vessels 105, as well as a submarine 107. The naval unit 101 moves in the naval unit direction of travel 109.

Around the naval unit there are vessels, aircraft, and submarines. Among the ships are the first foreign vessel 159, which moves in travel direction 161, and the second foreign vessel 163, which moves in travel direction 165 and a third foreign vessel 167, which moves in travel direction 169. Furthermore, there is a submarine 155 near the naval unit 101, moving in travel direction 157. In addition to this, a foreign aircraft 151 flies over the area in direction 153.

All foreign vessels 159, 163, 167 and the aircraft 151 are monitored and captured by the radar 133. The radio antenna 135 serves to inform all escort vessels 105 and the submarine 107, which has an above-water antenna, about the location of the radar 133 that has been determined by means of a radio signal sequence from an emitting HF transmitter 135.

The first foreign vessel 159 is identified as a danger for the naval unit 101 due to its travel direction 161 and assumedly greatly accelerated travel. In order to promptly communicate the positions, speed, and direction of the first foreign vessel 159 to all members of the naval unit 101, high-definition data are transmitted with priority by radio and the respective data link system to all members of the naval unit 101.

The data regarding the aircraft 151 moving in direction 153, and hence away from the naval unit 101, are not transmitted to the members of the naval unit continuously, but only communicated to the members of the naval unit every few minutes, since this aircraft 151 is assumed to be a low hazard by the radar 133 and the subsequent scoring algorithms.

The same applies for the second foreign vessel 163, which also distances itself in the direction 165 from the naval unit 101.

The information regarding the third foreign vessel 167, which moves in travel direction 169 at a lower speed than the velocity of the naval unit 101, is communicated to the members of the naval unit at medium priority, since, at that moment, the naval unit moves somewhat faster than the third foreign vessel 167.

The escort submarine 107 belonging to the naval unit has a passive sonar. This passive sonar is used to detect the foreign submarine 155 and its travel direction 157. Due to the fact that the foreign submarine 155 moved in the direction 157 of the naval unit 101 with relevant speed, the escort submarine 107 sends all data about the foreign submarine 155 in its transmission cycle with priority. This data includes the travel direction 157 as well as the speed of the foreign submarine 155.

The signal emitted/received in the data link system by means of the HF transmitter/receiver to or from the aircraft carrier, to or from the submarine 107, as well as to or from the escort vessels 105, is shown as an example in FIG. 2.

A radio signal sequence 250 has several frames 251, 253, 257, 259. Each of those frames in turn has a header 271, a trailer 273, and a bit sequence 275 data D that represent the information to be transmitted. The frame has a temporal width t1.

The radio signal sequence 250 is shown along a timeline 255. The individual sequences are assigned to the aircraft carrier 103, the escort vessels 105, and the escort submarine 107.

In this way, the emitted radio signal of the aircraft carrier 103 has six frames. Those six frames create a sequence. The sequence of the escort vessels 105 has two frames. The sequence of the escort submarine 107 has, in this case, three frames. The sequence procedure is to be as follows. First, the transmission sequence of the escort submarine 107, then, the transmission sequence of the aircraft carrier 103, and, ultimately, the transmission sequence of the escort vessels are sent, and, subsequently, the sequence, once more, of the escort submarine 107, then, the aircraft carrier, etc. This structure is repeated regularly.

If one now discovers, based upon the radar 133, that a foreign vehicle such as, for example, the first foreign vessel 159 displays an excessive velocity in the direction of the naval unit 101, the information regarding the first foreign vessel 159 in the frames one, two, and three is sent with priority.

The foreign vessel 169 classified as a medium danger is transferred in the frame four, and the other aircraft and vehicles in frame five, to all members of the naval unit 101 by means of the HF transmitter 135. Frame six provides a text message for the escort vessels.

If the first foreign vessel 159 should turn away from the naval unit, this foreign vessel is no longer classified as a primary danger, but as an average hazard, and the transmission of respective data occurs only in the third frame.

The frames sent by the escort submarine 107 follow an analogous procedure, with those frames being filled with all the information about the foreign submarine, due to the danger represented by the foreign submarine 155. If no underwater targets are detected, it can in this case be determined via the data link system that the submarineis, at the moment, no longer sending three frames during its sequence, but only one frame. However, as soon as the passive sonar of the submarine detects an underwater signal that is potentially dangerous, a frame informs the data link system that several frames are provided for the signal emitted by the escort submarine 107.

In an alternative embodiment, the bit sequences found in the data part of a frame are prioritized or are ordered accordingly, instead of the frames in their sequence. In this way, the first two-thirds may refer to a hazardous situation and the last third of the bits may be used to transmit general position data or voice information.

### LIST OF REFERENCE SYMBOLS

101 Naval unit
103 Aircraft carrier
105 Escort vessel
107 Escort submarine
109 Travel direction of naval unit
131 Aircraft
133 Radar
135 HF transmitter/receiver
151 Foreign aircraft
153 Flight direction
155 Foreign submarine
157 Foreign submarine travel direction
159 First foreign vessel
161 First foreign vessel travel direction
163 Second foreign vessel
165 Second foreign vessel travel direction
167 Third foreign vessel
169 Third foreign vessel travel direction
250 Radio signal sequence
251 Frame
253 Frame
255 Timeline
257 Frame
259 Frame
261 Time interval between frame 259 and frame 257
271 Header
273 Trailer
275 Data

1. A method for processing a radio signal sequence for distributing information in a data link system, said method comprising
producing a radio signal having at least a first frame and a second frame,
assigning the first frame having a first bit sequence to a first time slot,
assigning the second frame having a second bit sequence to a second time slot, and
defining a chronological sequence of the first frame and of the second frame or of the first bit sequence or of the second bit sequence, said defining on the basis of a sensor result.

2. A method according to claim 1, wherein said method further comprises assigning further frames to its own time slot, wherein the chronological sequence of the frames or the individual bit sequences of the frames is determined by the sensor findings, and generating a first signal transmission cycle formed by at least one of the frames.

3. A method according to claim 2, wherein said method further comprises generating further transmission cycles which in turn have frames with time slots assigned to them and whose chronological sequence within a transmission cycle is determined by the sensor findings.

4. A method according to claim 1, wherein said method further comprises defining the sensor findings using a scoring algorithm.

5. A method according to claim 1, wherein said method further comprises having a transmitter assigned for sending each frame.

6. A method according to claim 1, wherein said method further comprises transmitting at least two frames originating from at least two independent transmitters.

7. A method according to claim 1, wherein the first and second frames comprise sensor data or processed sensor data.

8. A method according to claim 1, wherein said method further comprises including a control signal in the radio signal sequence by which a second sensor may be controlled.

9. A transmitter with an allocated sensor, wherein the transmitter is configured so that a radio signal sequence obtained according to claim 1 be transmitted.

10. A receiver configured so that a radio signal sequence obtained according to claim 1 can be evaluated.

11. A receiver according to claim 10, wherein said receiver is associated with a sensor that may be controlled by means of the radio signal sequence.

12. Apparatus or vehicle comprising a watercraft, submarine, land vehicle or aircraft, having a transmitter according to claim 9.

13. (canceled)

14. Apparatus or vehicle comprising a watercraft, submarine, land vehicle or aircraft, said apparatus or vehicle having a receiver according to claim 10.

15. A data link system including an apparatus or a vehicle having (a) a transmitter with an allocated sensor, said transmitter configured to transmit a radio signal obtained according to claim 1; (b) a receiver configured to evaluate a radio signal obtained according to claim 1; and/or (c) a transmitter with an allocated sensor, said transmitter configured to transmit a radio signal obtained according to claim 1 and a receiver configured to evaluate a radio signal obtained according to claim 1, wherein said apparatus or vehicle comprises a watercraft, submarine, land vehicle or aircraft.
